(19) United States
(12) Patent Application Publication
(10) Pub. No.: US 2021/0258513 A1
(43) Pub. Date: Aug. 19, 2021

(54) METHOD FOR CREATING VIDEO CONTENT WITH A VIRTUAL BACKGROUND PRESENTATION

(71) Applicant: STUDY SOCIAL INC., Gainesvile, FL (US)

(72) Inventor: Ethan Fieldman, Gainesville, FL (US)

(73) Assignee: STUDY SOCIAL INC., Gainesville, FL (US)

(21) Appl. No.: 17/308,964

(22) Filed: May 5, 2021

(51) Int. Cl. H04N 5/272; H04N 9/75; G11B 27/036

(52) U.S. Cl. CPC H04N 5/272; H04N 2005/2726; G11B 27/036; H04N 9/75

(57) ABSTRACT

A method for creating a combined video presentation by combining a first video layer of a subject filmed in front of a chroma key background, a second virtual background presentation layer, and a third video layer of a person assisted by the subject to provide a presentation of information relating to the virtual background presentation layer.

### BACKGROUND OF THE INVENTION

The types and availability of live streaming and recorded video content continues to grow. Zoom (from Zoom Video Communications, Inc., San Jose, Calif.) and similar video streaming and conferencing applications now provide virtual backgrounds using chroma key. Such virtual backgrounds include the ability to show presentation images, such as electronic slides (e.g. PowerPoint from Microsoft Corporation, Redmond, Wash.) in combination with video of the speaker presenting the presentation images.

However, the capability of a speaker to interact with the slides from the viewpoint of those watching the video stream or recording is limited to a speaker designated area of the screen and without the ability for the speaker to show or use subject matter, such as objects or hands in three dimensions, to assist with more clearly conveying the presentation to viewers. Accordingly, there is a need for display of video content that includes virtual background presentation images in combination with both a speaker video and a video of subject matter that assists the speaker in presenting information associated with the virtual background presentation images.

### SUMMARY

Disclosed are systems, apparatuses, methods, computer readable medium, and circuits for creating video content combining speaker and assistive subject video layers with a virtual background presentation layer. According to at least one example, a method includes: providing a first video layer from a video camera filming a subject with a chroma key background in a first video, superimposing the subject of the first video layer over a second virtual presentation background layer displaying one or more images from an electronic file or from a second video as part of a combined live streaming or recorded presentation video, wherein the combined presentation video further includes a third video layer of a person superimposed over the virtual presentation background layer and providing information about the virtual presentation background layer with assistance from the subject. For example, the video recording and live streaming application software provides a first video layer from a video camera films a subject with a chroma key background in a first video; superimposes the subject of the first video layer over a second virtual presentation background layer displaying one or more images from an electronic file or from a second video as part of a combined presentation video, wherein the combined presentation video further includes a third video layer of a person superimposed over the virtual presentation background layer and providing information about the virtual presentation background with assistance from the subject.

In another example, video recording and live streaming application software for creating video content combining media layers with a virtual background presentation is provided that operates in a computing device operating system in combination with a storage (e.g., a memory configured to store data, such as virtual content data, one or more images, etc.) and one or more processors (e.g., implemented in circuitry) coupled to the memory and configured to execute instructions and, in conjunction with various components (e.g., a network interface, a display, an output device, etc.), cause the video recording and live streaming application software to: provide a first video layer from a video camera film a subject with a chroma key background in a first video; superimpose the subject of the first video layer over a second virtual presentation background layer displaying one or more images from an electronic file or from a second video as part of a combined presentation video, wherein the combined presentation video further includes a third video layer of a person superimposed over the virtual presentation background layer and providing information about the virtual presentation background layer with assistance from the subject.

### BRIEF DESCRIPTION OF THE DRAWINGS

FIG. 1 shows an example of a system for implementing certain aspects of the present technology.

FIG. 2 is a flowchart of a method for superimposing a first assisting subject video layer over a second virtual background presentation layer with a third video layer of a person superimposed over the virtual background presentation layer according to an embodiment of the instant disclosure.

FIG. 3 is a flowchart of a method for combining a first assisting subject video layer with a second virtual background presentation layer and with a third video layer of a person according to an embodiment of the instant disclosure.

FIG. 4 is relational diagram illustrating video creation software receiving a first video of an assisting subject, receiving second video of a person conducting a presentation, receiving image or video from an electronic file for a virtual background presentation and outputting a combined presentation video that layers the assisting subject and person over the virtual background presentation according to an embodiment of the instant disclosure.

FIG. 5 is a schematic diagram illustrating a camera filming an assisting subject with a chroma key background to create a first video layer of the assisting subject according to an embodiment of the instant disclosure.

FIG. 6 is an image of the solar system as an illustrative example of a graphic media used as virtual background layer according to an embodiment of the instant disclosure.

FIG. 7 is a schematic diagram illustrating a video of a presenting person with a chroma key background to create a second video layer of the presenting person according to an embodiment of the instant disclosure.

FIG. 8 is a transparent diagram of the combined presentation video that combines the first video layer of the assisting subject of FIG. 5 and the second video layer of FIG. 7 as superimposed over the virtual background layer of FIG. 6 according to an embodiment of the instant disclosure.

FIG. 9 is schematic diagram illustrating a first video layer of an assisting subject with a defined screen region area less than the virtual background layer's screen region area according to an embodiment of the instant disclosure.

FIG. 10 is a transparent diagram of the combined presentation video that combines the first video layer of the assisting subject of FIG. 9 and the second video layer of FIG. 7 as superimposed over the virtual background layer of FIG. 6 according to an embodiment of the instant disclosure.

### DETAILED DESCRIPTION

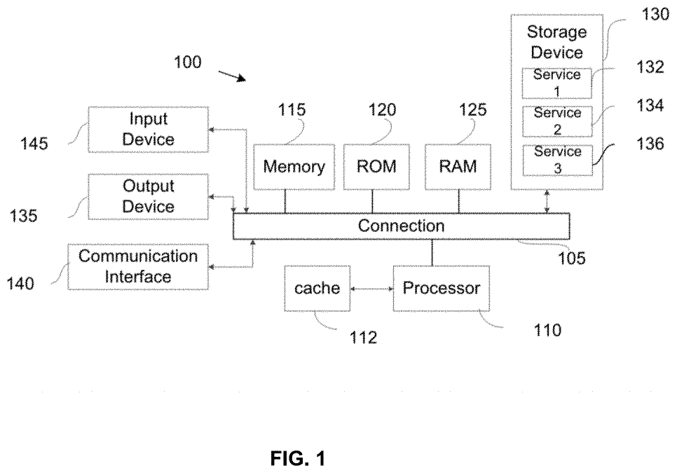

FIG. 1 shows an example of computing system 100, which can be for example any computing device running an operating system or any component thereof in which the components of the system are in communication with each other using connection 105. Connection 105 can be a physical connection via a bus, or a direct connection into processor 110, such as in a chipset architecture. Connection 105 can also be a virtual connection, networked connection, or logical connection.

In some embodiments, computing system 100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 100 includes at least one processing unit (CPU or processor) 110 and connection 105 that couples various system components including system memory 115, such as read-only memory (ROM) 120 and random access memory (RAM) 125 to processor 110. Computing system 100 can include a cache of high-speed memory 112 connected directly with, in close proximity to, or integrated as part of processor 110.

Processor 110 can include any general purpose processor and a hardware service or software service, such as services 132, 134, and 136 stored in storage device 130, configured to control processor 110 as well as a special-purpose processor where software instructions are incorporated into the actual processor design. Processor 110 may essentially be a completely self-contained computing system, containing multiple cores or processors, a bus, memory controller, cache, etc. A multi-core processor may be symmetric or asymmetric.

To enable user interaction, computing system 100 includes an input device 145, which can represent any number of input mechanisms, such as a microphone for speech, a touch-sensitive screen for gesture or graphical input, keyboard, mouse, motion input, speech, etc. Computing system 100 can also include output device 135, which can be one or more of a number of output mechanisms known to those of skill in the art. In some instances, multimodal systems can enable a user to provide multiple types of input/output to communicate with computing system 100. Computing system 100 can include communications interface 140, which can generally govern and manage the user input and system output. There is no restriction on operating on any particular hardware arrangement, and therefore the basic features here may easily be substituted for improved hardware or firmware arrangements as they are developed.

Storage device 130 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 130 can include software services, servers, services, etc., that when the code that defines such software is executed by the processor 110, it causes the system to perform a function. In some embodiments, a hardware service that performs a particular function can include the software component stored in a computer-readable medium in connection with the necessary hardware components, such as processor 110, connection 105, output device 135, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

In various embodiments, live streaming and recorded video content may be created according to the invention through us of video creation software applications such as Open Broadcaster Software (OBS) (available from obsproject.com) and those with like functionality to combine video and media layers into a combined video stream or recording

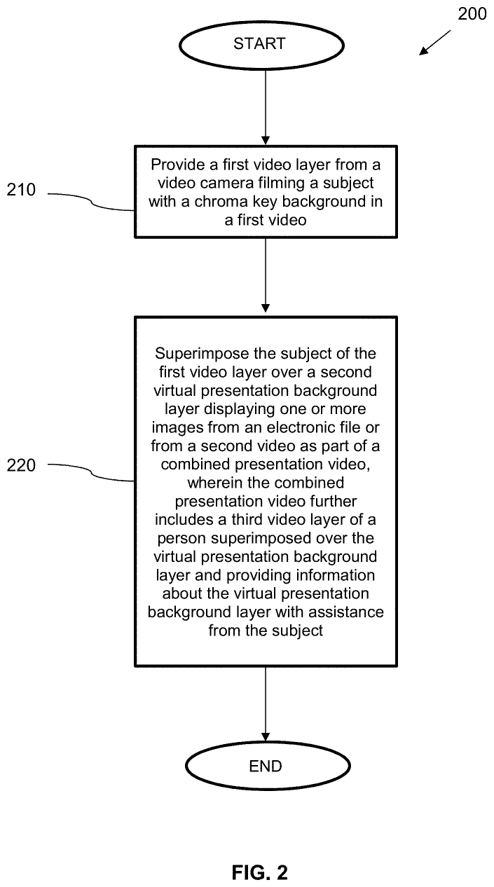

FIG. 2 illustrates an example method 200 for superimposing a first video layer of a subject over a second virtual background presentation layer and wherein a third video layer of person is also superimposed over the virtual background presentation layer. Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence.

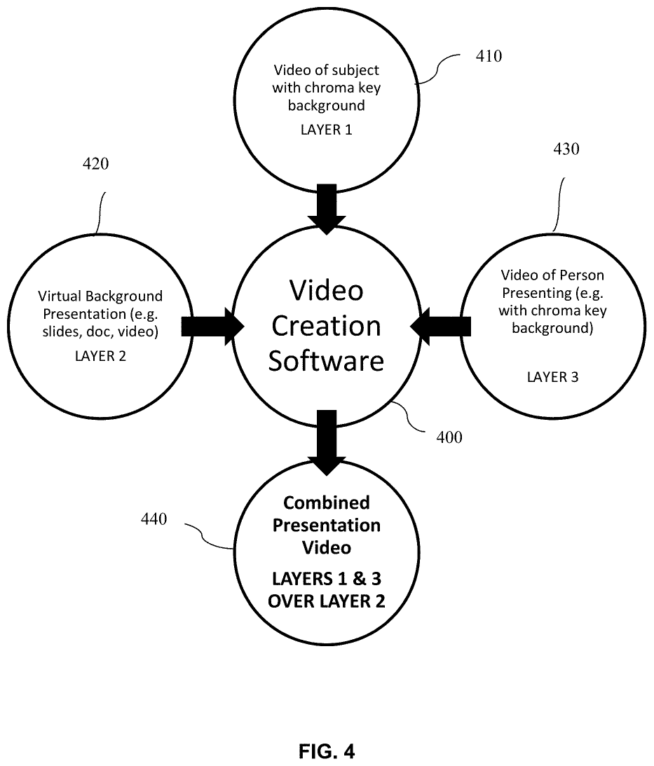

According to some embodiments, the method includes providing a first video layer 410 from a video camera 510 filming a subject 500 with a chroma key background 520 in a first video at step 210. For example, the video creation software application 400 illustrated in FIG. 4 may receive a first video of a subject 500 with a chroma key background 520 in a first video to generate a first video layer 410 of the subject.

According to some embodiments, the method includes superimposing the subject 500 of the first video layer 410 over a second virtual presentation background layer 420 displaying one or more images from an electronic file or from a second video as part of a combined presentation video 440 at step 220. For example, the video creation software application 400 illustrated in FIG. 4 may superimpose the subject 500 of the first video layer 410 over a second virtual presentation background layer 420 displaying one or more images from an electronic file or from a second video as part of a combined presentation video. In some embodiments, the combined presentation video 440 further includes a third video layer 430 of a person 710 superimposed over the virtual presentation background layer 420 and providing information about the virtual presentation background layer 420 with assistance from the subject 500.

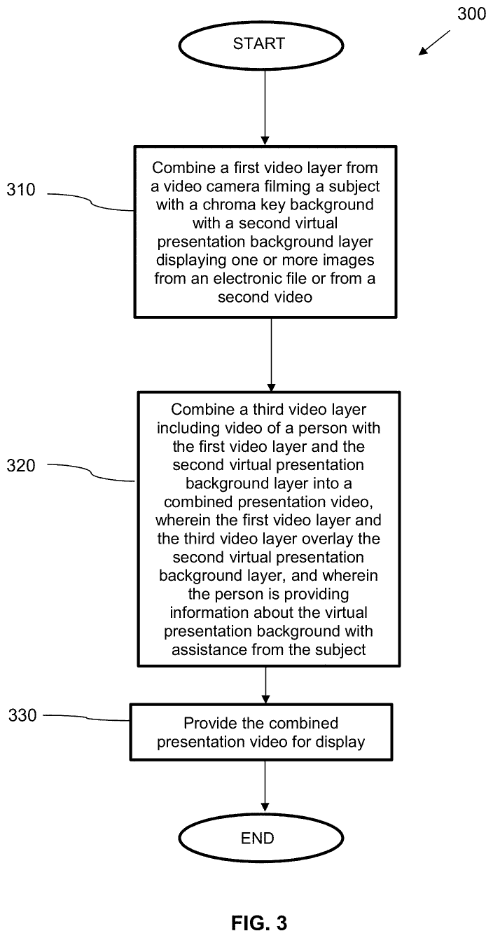

FIG. 3 illustrates another example method 300 for combining a first video layer 410 of a subject 500, a second virtual background presentation layer 420, and a third video layer of person 430 over the virtual background presentation layer 420. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some embodiments, the method includes combining a first video layer 410 from a video camera 510 filming a subject 500 with a chroma key background 520 with a second virtual presentation background layer 420 displaying one or more images from an electronic file or from a second video at step 310. For example, the video creation software application 400 illustrated in FIG. 4 may combine a first video layer 410 from a video camera 510 filming of a subject 500 with a chroma key background 520 with a second virtual presentation background layer 420 displaying one or more images from an electronic file or from a second video.

According to some embodiments, the method includes combining a third video layer 430 including video of a person 710 with the first video layer 410 and the second virtual presentation background layer 420 into a combined presentation video 440 at step 320. For example, the video creation software application 400 illustrated in FIG. 4 may combine a third video layer 430 including video of a person 710 with the first video layer 410 and the second virtual presentation background layer 420 into a combined presentation video 440. In some embodiments, the first video layer 410 and the third video layer 430 overlay the second virtual presentation background layer 430. In some embodiments, the person 710 is providing information about the virtual presentation background 420 with assistance from the subject 500.

According to some embodiments, the method includes providing the combined presentation video 440 for display at step 330. For example, the video creation software application 400 illustrated in FIG. 4 illustrated in FIG. 4 may provide the combined presentation video 440 as live stream or recorded video for display via a web browser, video display software application, video conferencing software application, and the like.

FIG. 4 illustrates video creation software 400 receiving a first video of an assisting subject 500 preferably with a chroma key background 520 and representing first video layer 410, receiving image or video from an electronic file for a second virtual background presentation layer 420, receiving second video of a person 710 preferably in front of a chroma key background 720 conducting a presentation and representing a third video layer 430 and outputting a combined presentation video 440 that layers the assisting subject 500 and person 710 over the second virtual background presentation layer 420 according to an embodiment of the instant disclosure.

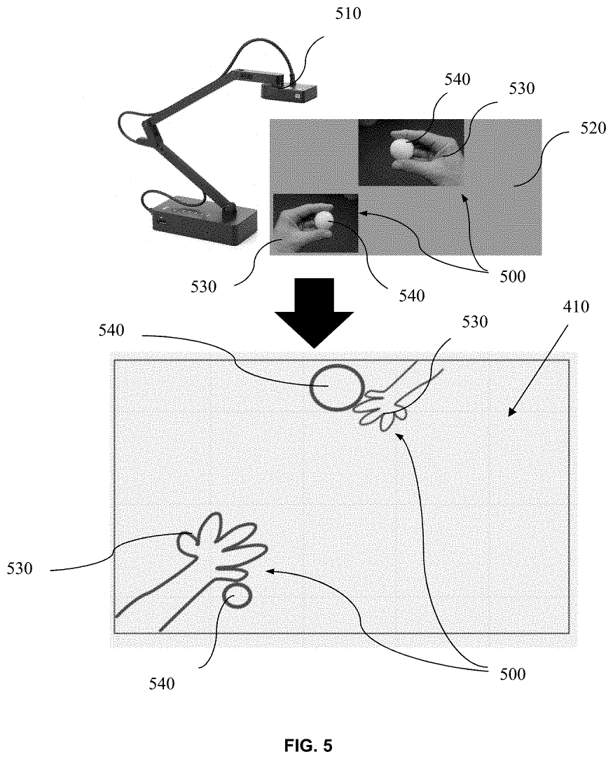

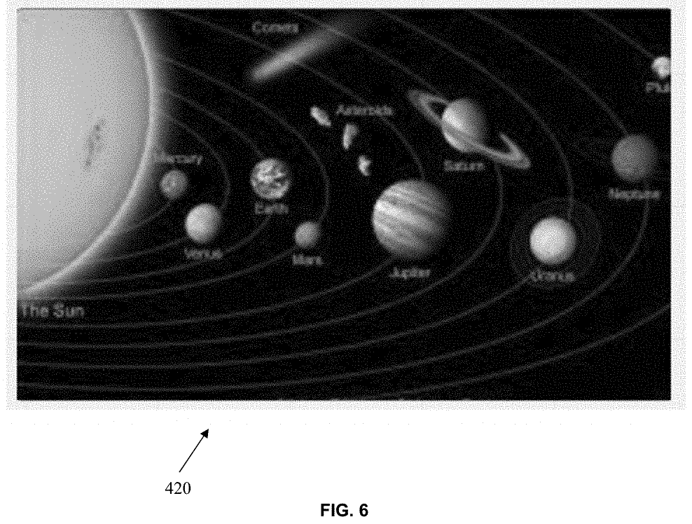

FIG. 5 illustrates a camera 510, such as a document camera in some embodiments, filming an assisting subject 500 with a chroma key background 520 to create a first video layer 410 of the assisting subject 500 according to an embodiment of the instant disclosure. In an example embodiment, the assisting subject 500 includes hands 530, such as hands of the presenting person 710 or other persons assisting the presentation, and may further include one or more objects 540, held by hands 530. It will be appreciated that displaying objects 540 according to embodiments of the invention allows providing 3-dimensional information about the objects and how they may relate or provide instruction about the virtual background layer 420. In the illustrated example the objects 540 of the subject 500 are balls to provide information regarding relative sizes of planets that relate to the solar system image background layer 420 as shown in FIG. 6. In other embodiments subject 500 may include a pointing device, such as a pointer, pointing stick, writing instruments and the like to enable pointing at points of interest in the virtual background presentation layer 420. In some embodiments the chroma key background 520 may be single colored material (e.g. “green screen”) that is a piece of paper (e.g. green sheet of paper), paperboard, cardboard, cloth, plastic, wood or the like. As shown in FIG. 4, video creation software 400 will ignore the chroma key background 520 behind the subject 500 so that a first assisting subject video layer 410 can be combined with the second virtual background layer 420 and third presenting person video layer 430 as a more robust and instructive combined presentation video 440 that is displayed in live streaming or recorded videos.

FIG. 6 is an image of the solar system as an illustrative example of a graphic media from an electronic file used as a second virtual background layer 420. In other embodiments, one or more other images from electronic files or from live or recorded video may be used as the virtual background layer 420, including an electronic slide presentation (e.g. PowerPoint), document, photo, graphic or image, or a video file.

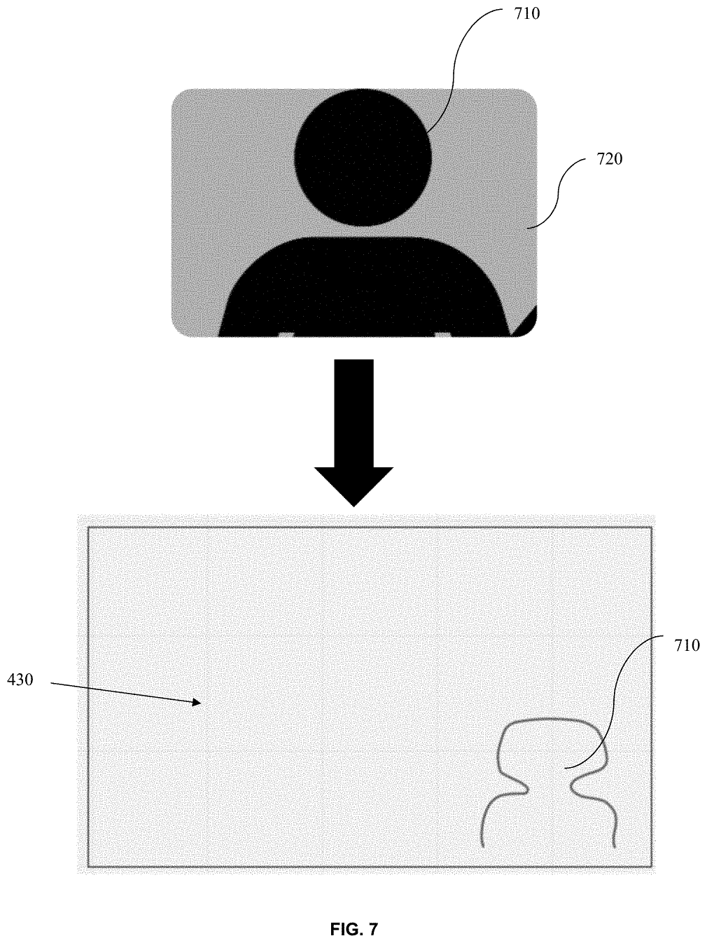

FIG. 7 illustrates creation of a third video layer 430 of a presenting person 710 with a chroma key background 720. In some embodiments the “talking head” of a person 710 is shown in the third video layer 430, while in other embodiments more of, including the entirety of the person 710, may be displayed. As shown in FIG. 4, video creation software 400 will ignore the chroma key background 720 behind the person 710 so the third presenting person video layer 430 can be combined with the second virtual background layer 420 and the first assisting subject layer 410 as a more robust and instructive combined presentation video 440 that is displayed in live streaming or recorded videos.

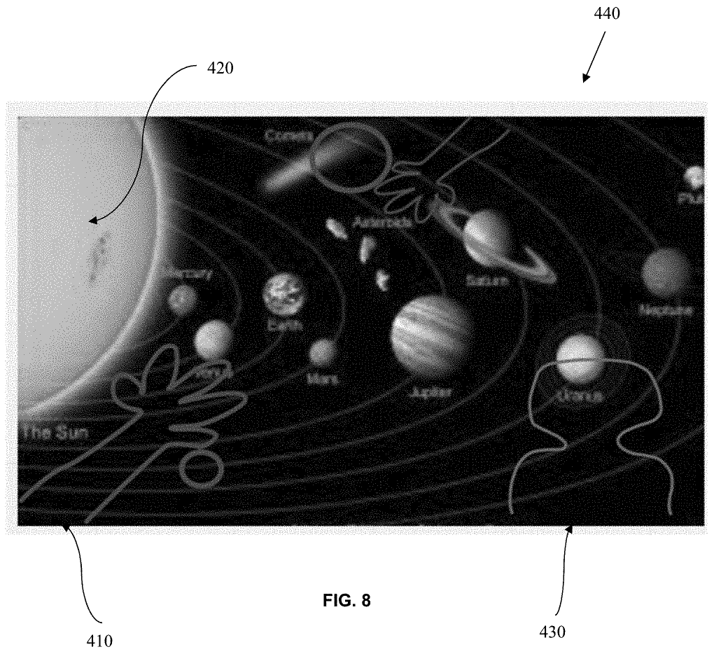

FIG. 8 illustrates the combined presentation video that combines the first video layer 410 of the assisting subject 500 of FIG. 5 and the second video layer 420 of FIG. 7 as superimposed over the virtual background layer 430 of FIG. 6. The schematic is shown in “transparent” format to better illustrate that first video layer 410 of subject 500 and third video layer 430 of person 710 are superimposed over second virtual background layer 420 in the combined video presentation 440. However, it will be appreciated that in the actual display of the combined video presentation 440 that subject 500 of layer 410 and person 710 of layer 430 are non-transparent and appear solidly (not see-through) in front of the virtual background layer 420. It will also be appreciated that in the embodiments of FIGS. 5-7 that result in the combined video presentation of FIG. 8 that the first video layer 410, the second virtual background layer 420 and the third presenting person video layer 430 all have the same defined screen region area. In other words, all of the layers have the same screen size. In other embodiments, the respective screen area regions for each layer may be defined to different sizes for one or more of the layers as is well-known in the functionality of conventional video creation software applications such as OBS.

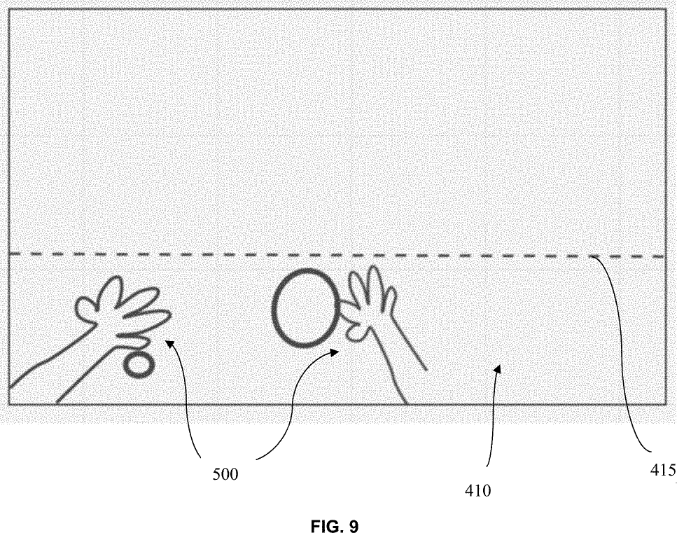

For example, FIG. 9 shows an alternative embodiment to FIGS. 5-8 wherein a first video layer 410 of an assisting subject 500 has a defined screen region area 415 less than the entire screen regions of the second virtual background layer 420 and third video layer 430 of the presenting person 710.

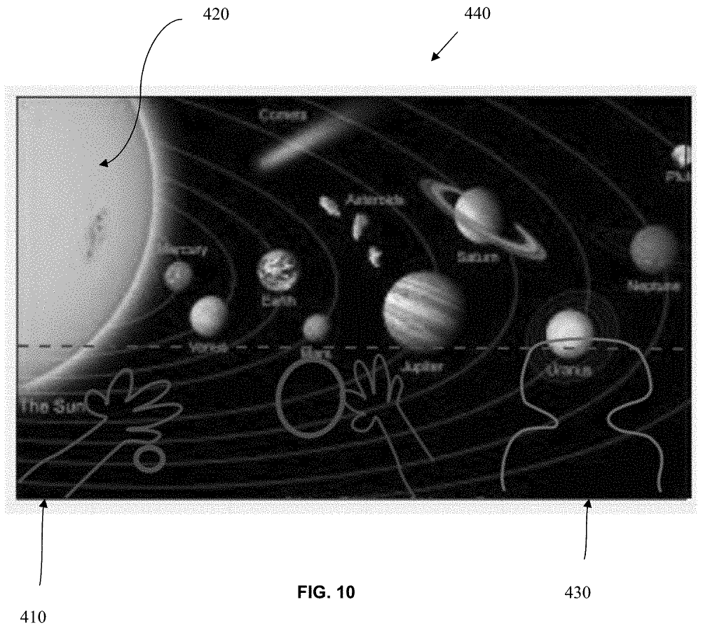

FIG. 10 is a transparent diagram of the combined presentation video 440 that combines the first video layer of the assisting subject of FIG. 9 and the third video layer 430 of FIG. 7 as superimposed over the virtual background layer 420 of FIG. 6. It will be appreciated the first video layer of subject 500 as shown in the combined presentation video 440 is confined to the defined screen region are 415 as compared to the co-extensive full screen regions for all of the layers of combined video presentation 440 shown in FIG. 8.

In further embodiments of the invention, one or more additional video layers (not shown) of different subjects, such as hands from different persons, could also be provided into the combined presentation video 440 as superimposed over the virtual background layer 420. For example, respective students and/or co-instructors may provide their hand(s) in front of a chorma key background (e.g. green screen or green sheet of paper) with a document camera so that each video feed of a respective hand(s) is another video layer in the combined presentation video 440. In various embodiments, these additional video layers will permit other users to interact, such as pointing or motioning, with elements in the other video layers, including the virtual background layer 420.

It will be appreciated that the software operator, in some instances presenting person 710, of the video creation software application receiving all of the video layers can change the ordering of layers (i.e. determine the respective ordering of layering in terms of priority of being superimposed over other layers), including re-ordering video layers during the presentation. Further, the operator can re-size the area of the video layers relative to the full screen size of the combined video presentation, including re-sizing of one or more video layers during the presentation.

Various embodiments of the invention have been described. It will, however, be evident that various modifications and changes may be made thereto, and additional embodiments may be implemented, without departing from the broader scope of the invention as set forth by the claims. This specification is to be regarded in an illustrative rather than a restrictive sense.

What is claimed is:

1. A method of creating video content comprising:
providing a first video layer from a video camera filming a subject with a chroma key background in a first video; and
superimposing the subject of the first video layer over a second virtual presentation background layer displaying one or more images from an electronic file or from a second video as part of a combined presentation video, wherein the combined presentation video further includes a third video layer of a person superimposed over the virtual presentation background layer and providing information about the virtual presentation background layer with assistance from the subject.

2. The method of claim 1, wherein the subject includes one or more hands.

3. The method of claim 2, wherein the one or more hands belong to said person.

4. The method of claim 3, wherein the video camera is a document camera and the chroma key background is a solid color of a piece of a material.

5. The method of claim 4, wherein the piece of material includes a sheet of paper.

6. The method of claim 1, wherein the video camera is a document camera and the chroma key background is a solid color of a piece of a material.

7. The method of claim 6, wherein the subject includes an object being held by one or more hands.

8. The method of claim 7, wherein the one or more hands belong to said person.

9. The method of claim 1, wherein the subject includes an object being held by one or more hands.

10. The method of claim 9, wherein the one or more hands belong to said person.

11. The method of claim 1, wherein the subject includes an object pointing at the virtual presentation background layer.

12. The method of claim 11, wherein the video camera is a document camera and the chroma key background is a solid color of a piece of a material.

13. The method of claim 1, wherein the virtual presentation background layer includes an image from an electronic slide presentation.

14. The method of claim 1, wherein the virtual presentation background layer includes an image from an electronic document.

15. The method of claim 1, wherein the virtual presentation background layer includes an image from a photo or image file.

16. The method of claim 1, wherein the virtual presentation background layer includes video images.

17. The method of claim 1, wherein the combined presentation video is a live streaming video.

18. The method of claim 1, wherein the combined presentation video is a recorded video.

19. A method of creating video content comprising:
combining a first video layer from a video camera filming a subject with a chroma key background with a second virtual presentation background layer displaying one or more images from an electronic file or from a second video;
combining a third video layer including video of a person with the first video layer and the second virtual presentation background layer into a combined presentation video, wherein the first video layer and the third video layer overlay the second virtual presentation background layer, and wherein the person is providing information about the virtual presentation background with assistance from the subject; and
providing the combined presentation video for display.

20. The method of claim 19, wherein the chroma key background is a solid color of a piece of a material and the subject includes one or more hands of said person.
